(19) United States
(12) Patent Application Publication
(10) Pub. No.: US 2016/0199757 A1
(43) Pub. Date: Jul. 14, 2016

(54) FILTER CARTRIDGE WITH ELLIPTICAL SHAPED PLEATS

(71) Applicant: In-Tec Water Products, LLC., St. Petersburg, FL (US)

(72) Inventors: John Nohren, Jr., St. Petersburg, FL (US); Brad Mierau, Tampa, FL (US)

(21) Appl. No.: 14/592,099

(22) Filed: Jan. 8, 2015

(51) Int. Cl. B01D 29/03

(52) U.S. Cl. CPC B01D 29/031

(57) ABSTRACT

A filter cartridge includes a first cylindrical shaped pleated filter element having a plurality of first outer pleats, each first outer pleat being elliptically shaped and having a sidewall. The filter cartridge further includes a second cylindrical shaped pleated filter element having a plurality of second outer pleats, each second outer pleat having a sidewall. The second cylindrical shaped pleated filter element is nested within the first cylindrical shaped pleated filter element with each second outer pleat disposed within a corresponding first outer pleat and with the sidewall of the second outer pleat substantially free of contact with the sidewall of the first outer pleat along the portion of the sidewall of the second out pleat that is disposed within the first outer pleat. This filter cartridge is particularly valuable in relatively small diameter in-line type filters and water bottle filters.

### FIELD OF THE INVENTION

The present invention relates generally to filter cartridges for filtering water, and more particularly, relating to a filter cartridge having a pleated filter element with elliptical shaped pleats.

### BACKGROUND OF THE INVENTION

Filter cartridges having cylindrically shaped, pleated filter elements are commercially available and are widely used, for example, in drinking water filtering systems. When filtering water for consumption, it is desirable to remove both biological and chemical contaminants from the source water according to recommend levels established by the Environmental Protection Agency (EPA) and the World Health Organization (WHO). Filtering source water to these recommend levels has been problematic in connection with portable water filtering systems, such as, for example, water bottles equipped with filters, in-line filters for hydration packs, and the like.

Filter cartridges having filter elements of charged layer membrane (CLM) material have demonstrated promising results for use in portable water filtering systems. It has been determined, however, that in small diameter filter cartridges, such as those used in water bottles and in-line filters, that pleated filter elements of CLM material are prone to low performance as a result of pleat sidewall contact, which is especially problematic at the pleat apex when the pleat apex included angle is about or less than 10-degrees.

Additionally, while CLM material is advantageous, it has been determined that in small diameter filter cartridges, a single filter element may not be sufficient to properly filter the source water to EPA and WHO recommended levels. However, because CLM material is prone to reduced performance cause by surface contact with adjacent filter material, simply constructing a dual layer filter element has not provided satisfactory results, particularly in the smaller diameter filters with an outer diameter of less than 38 mm.

In view of the foregoing, there is a desire for a filter cartridge of a new construction that has reduced pleat apex occlusion and that may comprise two pleated filter elements.

### SUMMARY OF THE INVENTION

In view of the foregoing disadvantages inherent in the known types of filter cartridges now present in the prior art, the present invention provides a new filter cartridge construction that has eliminated occlusion at the pleat apex and that may include two cylindrically pleated filter elements arranged in a nested configuration.

In general, in one aspect, a filter cartridge is provided that includes a cylindrical shaped pleated filter element having a plurality of outer pleats where each outer pleat is elliptically shaped. There are several advantages provided with an elliptically shaped outer pleat. One advantage is an elliptical shaped pleat provides more filter surface area compared to a standard, sharp-folded pleat with the same filter diameter. An elliptical pleat provides approximately 12-30% more surface area as compared to a standard pleat. Another advantage is reduced occlusion at the pleat apex because the pleat has more of an open area configuring compared to a standard pleat, which prevents sidewall contact at the pleat apex.

Yet another advantage to a filter element having elliptically shaped pleats is the ability to combine two pleated filter elements together, in a nested configuration, within a small filter diameter that otherwise would not be possible because of contact between the two filter elements that would result in filter occlusion.

Therefore, in general, in yet another aspect, a filter cartridge is provided that includes a first cylindrical shaped pleated filter element having a plurality of first outer pleats, each first outer pleat being elliptically shaped and having a sidewall. The filter cartridge further includes a second cylindrical shaped pleated filter element having a plurality of second outer pleats, each second outer pleat having a sidewall. The second cylindrical shaped pleated filter element is nested within the first cylindrical shaped plated filter element with each second outer pleat disposed within a corresponding first outer pleat and with the sidewall of the second outer pleat substantially free of contact with the sidewall of the first outer pleat along the portion of the sidewall of the second outer pleat that is disposed within the first outer pleat. This filter cartridge is particularly valuable in relatively small diameter in-line type filters and water bottle filters.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

The following drawings illustrate by way of example and are included to provide further understanding of the invention for the purpose of illustrative discussion of the embodiments of the invention. No attempt is made to show structural details of the embodiments in more detail than is necessary for a fundamental understanding of the invention, the description taken with the drawings making apparent to those skilled in the art how the several forms of the invention may be embodied in practice. Identical reference numerals do not necessarily indicate an identical structure. Rather, the same reference numeral may be used to indicate a similar feature of a feature with similar functionality. In the drawings:

FIG. 1 is a diagrammatic view of a filter cartridge having a pleated filter element with elliptical shaped pleats that is constructed in accordance with the principles of an embodiment of the present invention;

FIG. 2 is a diagrammatic cross-section view of the filter cartridge of FIG. 1 taken along line 2-2 in FIG. 1;

FIG. 3 is an enlarged, diagrammatic view of the pleat construction of the filter cartridge of FIG. 1;

FIG. 4 is a diagrammatic cross-section view of an in-line filter assembly having a filter cartridge constructed in accordance with an embodiment of the present invention;

FIG. 5 is a diagrammatic cross-section view of the in-line filter assembly of FIG. 4 taken along line 5-5 in FIG. 4;

FIG. 6 is a diagrammatic view a filter cartridge constructed in accordance with an embodiment of the present invention for use in connection with a sports bottle; and

FIG. 7 is a diagrammatic cross-section view of the filter cartridge of FIG. 6 taken along line 7-7 in FIG. 6.

### DETAILED DESCRIPTION OF THE INVENTION

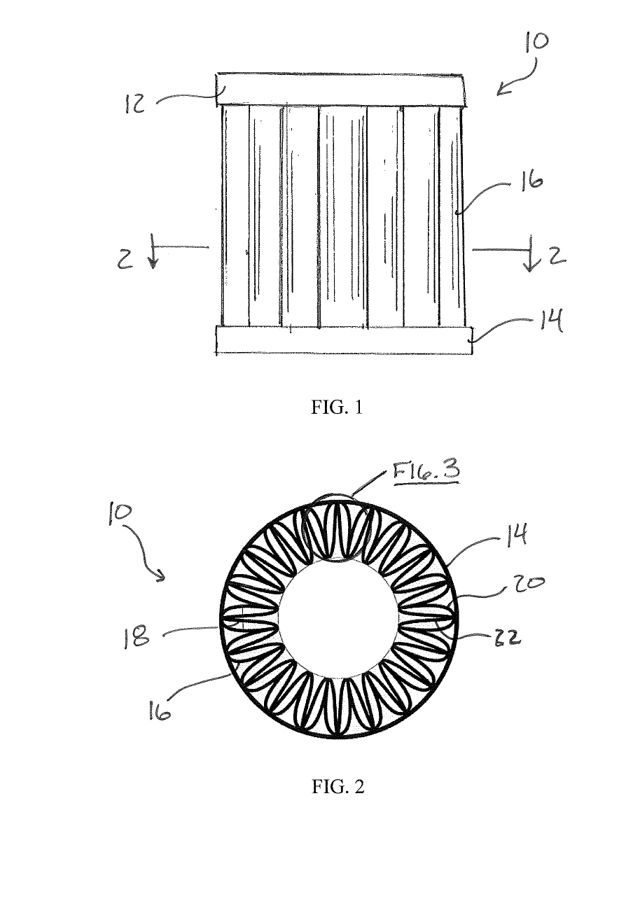

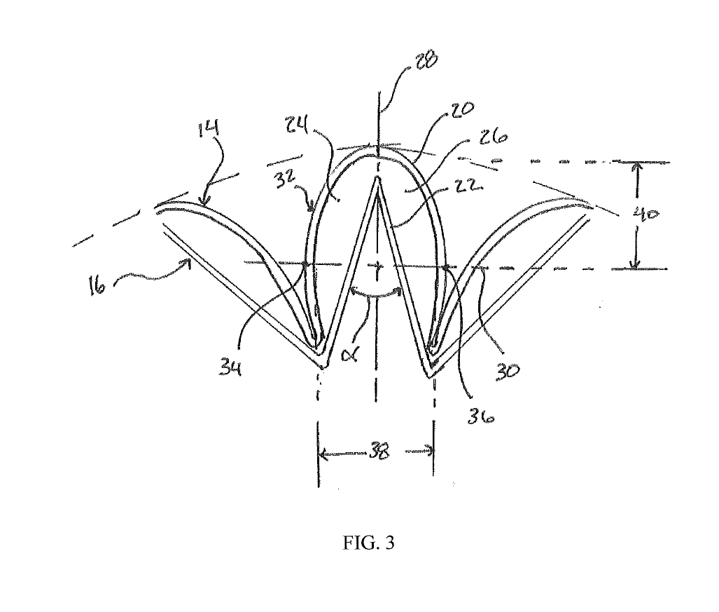

Initially referring to FIGS. 1 and 2, there is representatively illustrated an embodiment of the filter cartridge 10. The filter cartridge 10 includes a pair of end caps 12 and 14 and cylindrical, pleated filter elements 16 and 18 that extend between end caps 12 and 14 and are sealing affixed to the end caps with a suitable adhesive. The filter element 18 has a smaller outer diameter than the outer diameter filter element 16 and filter element 18 is nested within filter element 16 with each pleat 22 of filter element 18 disposed within a corresponding pleat 20 of filter element 16.

With further reference to FIG. 3, to prevent contact between the sidewalls of pleats 20 and 22, each pleat 20 has an elliptical shape that allows pleat 22 to be disposed within pleat 20 with the sidewalls of pleat 20 substantially free of contact with the sidewalls of pleat 22 by a space 24, 26 located between the pleat sidewalls. The space 24, 26 extends substantially along the entire length of the pleat sidewalls. The space 24, 26 prevents filter occlusion that otherwise would be caused by contact between the pleat sidewalls of pleats 20 and 22. This construction is particularly useful for filter elements of charged layer membrane (CLM) filter material, which are susceptible to lower filtering efficiency resulting from surface contact between pleats thus effectually reducing the effective surface area. Embodiments include one or both of the filter elements 16 and 18 constructed of CLM filter material.

With continued reference to FIG. 3, each pleat 20 of the first filter element 14 includes a major axis 28 that extends in a radial direction relative to the filter element. Each pleat 20 also includes a minor axis 30 that extends perpendicular to the major axis 28. Each pleat 20 further includes a smooth arcuate curved sidewall portion 32 that extends between the intersections of said minor axis and the circumference of said exterior pleat, indicated by elements 34 and 36. Each pleat 20 is further characterized by a minor diameter 38 that extends along the minor axis 30 and between the pleat sidewall and a major dimension 40 that extends along the major axis 28 between the intersection of the major and minor axes and the pleat sidewall. In an embodiment, the minor diameter 38 is at least about 5 times a normalized sidewall thickness of pleat 20. In an embodiment, the major dimension 40 is about greater than or equal to 2.5 times a normalized sidewall thickness of pleat 20. Additionally, in an embodiment, each pleat 22 constructed to have reduced pleat occlusion by having a pleat included angle α that is at least 10-degrees, or greater.

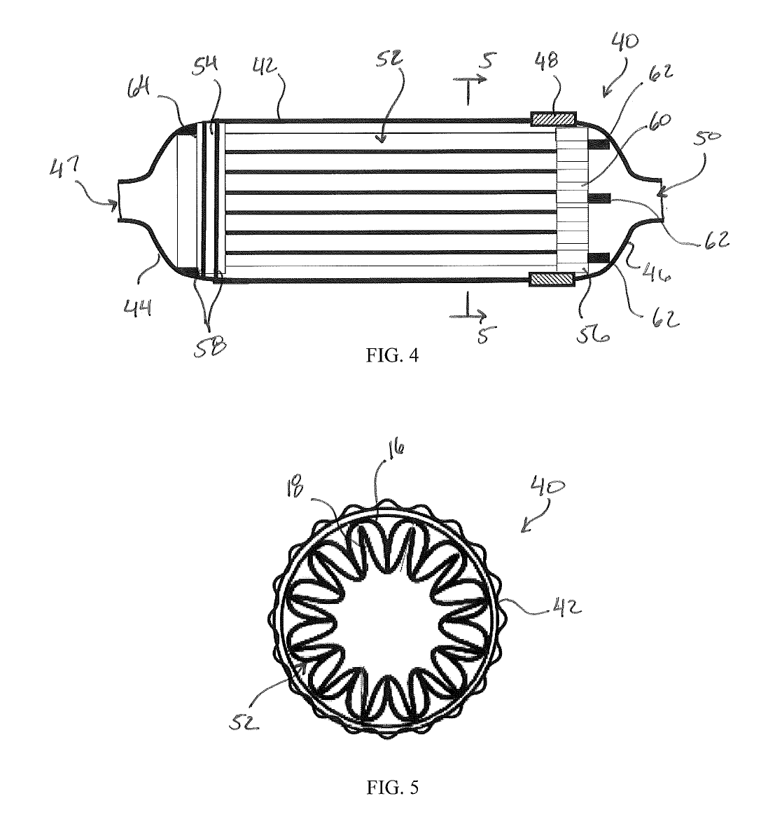

With reference to FIG. 4, there is representatively illustrated a cross-section of an in-line filter assembly 40. Filter assembly 40 includes a filter housing 42 having opposite ends 44 and 46. End 44 is formed integral with housing 42 and includes an opening 47. End 46 is removably connected to housing 42 by cooperative threads 48 and includes an opening 50. Disposed within the housing 42 is a filter cartridge 52 that is constructed in accordance with the filter cartridge 10 discussed above and illustrated in FIGS. 1-3. Here, filter cartridge 52 includes end caps 54 and 56. End cap 54 is fitted with one or more O-rings 58 to seal end cap 54 with the housing 42 to prevent fluid by-pass across end cap 54. Further, end cap 56 has a plurality of grooves 60 formed around its circumference to allow water entering the housing 42 through opening 50 to flow through the groves and then radially across the filter cartridge 52. End 46 includes a plurality of offsets 62 that urge against the end of the filter cartridge 52 to push the opposite end of the filter cartridge against shoulder 64 of end 42 when end 46 is threaded onto the filter housing 42 to position and seat the filter cartridge within the filter housing.

In FIG. 5, there is representatively illustrated a transverse cross-section of the in-line filter assembly 40 illustrated in FIG. 4. Filter cartridge 52 is constructed in the same manner as filter cartridge 10 discussed above and includes the same nested filter elements 16 and 18 and their respective constructions.

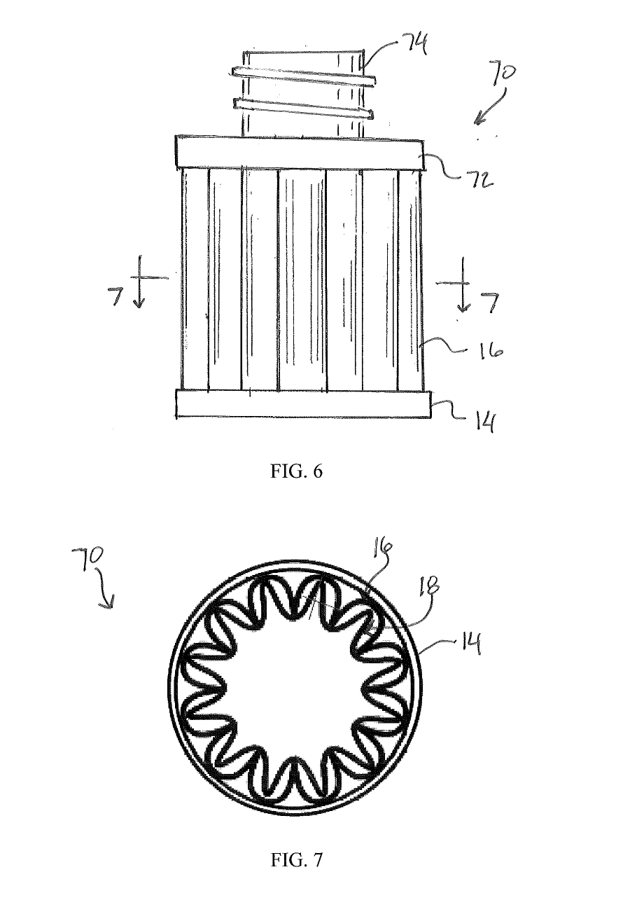

With reference to FIG. 6, there is representatively illustrated sports bottle filter cartridge 70 for use in connection with a portable drinking container, such as, for example, a water bottle. Filter cartridge 70 is constructed in accordance with the filter cartridge 10 discussed above and illustrated in FIGS. 1-3. Here, end cap 12 is replaced with end cap 72 that includes a threaded neck 74. Threaded neck 74 is configured to be connected to a bottle cap of a water bottle by screwing the threaded neck into the bottle cap.

In FIG. 7, there is representatively illustrated a transverse cross-section of the sports bottle filter cartridge 70 illustrated in FIG. 6. Filter cartridge 70 is constructed in the same manner as filter cartridge 10 discussed above and includes the same nested filter elements 16 and 18 and their respective constructions.

A number of embodiments of the present invention have been described. Nevertheless, it will be understood that various modifications may be made without departing from the spirit and scope of the invention. Accordingly, other embodiments are within the scope of the following claims.

What is claimed is:

1. A filter cartridge comprising:
a cylindrical shaped pleated filter element having a plurality of outer pleats; and
each exterior pleat being elliptically shaped.

2. The filter cartridge of claim 1, wherein each outer pleat is characterized as having a major axis that extends in a radial direction relative to said cylindrical shaped pleated filter element and having a minor axis that extends perpendicular to said major axis.

3. The filter cartridge of claim 2, wherein each outer pleat has a smooth arcuate curved sidewall portion that extends between the intersections of said minor axis and the circumference of said exterior pleat.

4. The filter cartridge of claim 3, wherein each outer pleat includes a minor diameter that extends along said minor axis that is at least about 5 times a wall thickness of said outer pleat.

5. The filter cartridge of claim 1, further comprising:
a pair of end caps; and
said cylindrical shaped pleated filter element extending between and sealing affixed to said pair of end caps.

6. The filter cartridge of claim 5, wherein one of said pair of end caps includes a threaded neck.

7. The filter cartridge of claim 6, wherein one of said pair of end caps includes a plurality grooves spaced around the circumference of said end cap.

8. The filter cartridge of claim 1, wherein said cylindrical shaped pleated filter element is of charged layer membrane filter material.

9. A filter cartridge comprising:
a first cylindrical shaped pleated filter element having a plurality of first outer pleats, each first outer pleat being elliptically shaped and having a sidewall;
a second cylindrical shaped pleated filter element having a plurality of second outer pleats, each second outer pleat having a sidewall; and
said second cylindrical shaped pleated filter element nested within said first cylindrical shaped plated filter element with each second outer pleat disposed within a corresponding first outer pleat and with the sidewall of said second outer pleat substantially free of contact with the sidewall of the first outer pleat along the portion of said sidewall of said second out pleat that is disposed within said first outer pleat.

10. The filter cartridge of claim 9, wherein each first outer pleat is characterized as having a major axis that extends in a radial direction relative to said first cylindrical shaped pleated filter element and having a minor axis that extends perpendicular to said major axis.

11. The filter cartridge of claim 10, wherein each first outer pleat has a smooth arcuate curved surface that extends between the intersections of said minor axis and the circumference of said exterior pleat.

12. The filter cartridge of claim 3, wherein each first outer pleat includes a minor diameter that extends along said minor axis that is at least about 5 times a wall thickness of said sidewall of said first outer pleat.

13. The filter cartridge of claim 9, further comprising:
a pair of end caps;
said cylindrical shaped pleated filter element extending between and sealing affixed to said pair of end caps; and
said second cylindrical shaped pleated filter element extending between and sealing affixed to said pair of end caps.

14. The filter cartridge of claim 13, wherein one of said pair of end caps includes a threaded neck.

15. The filter cartridge of claim 13, wherein one of said pair of end caps includes a plurality grooves spaced around the circumference of said end cap.

16. The filter cartridge of claim 9, wherein at one of said first and said second cylindrical shaped pleated filter element is of charged layer membrane filter material.

17. The filter cartridge of claim 9, wherein said first and said second cylindrical shaped pleated filter element is of charged layer membrane filter material.
